(19) United States
(12) Patent Application Publication
(10) Pub. No.: US 2004/0186776 A1
(43) Pub. Date: Sep. 23, 2004

(54) System for automatically selling and purchasing highly targeted and dynamic advertising impressions using a mixture of price metrics

(76) Inventor: Eduardo F. Llach, Palo Alto, CA (US)

Correspondence Address: HAVERSTOCK & OWENS LLP, 162 NORTH WOLFE ROAD, SUNNYVALE, CA, 94086, US

(21) Appl. No.: 10/767,050

(22) Filed: Jan. 28, 2004

Related U.S. Application Data
(60) Provisional application No. 60/443,358, filed on Jan. 28, 2003.

(51) Int. Cl. G06F 17/60

(52) U.S. Cl. 705/14

(57) ABSTRACT

A system for and method of distributing advertisements to a medium are disclosed. In one embodiment, the method comprises classifying a plurality of messages according to a target criterion, selecting a message from the plurality of messages using a selection criterion, and delivering the selected message to a content site comprising a medium adapted to display a corresponding advertisement of the message. The selection criterion comprises a cost associated with the message. Preferably, another selection criterion is that the content site meets one of a target, payment, and constraint of a message deal associated with the selected message. The message is either a text message, a video message, or an audio message.

### RELATED APPLICATION

This application claims priority under 35 U.S.C. § 119(e) of the co-pending U.S. Provisional Application Serial No. 60/443,358, filed on Jan. 28, 2003, and titled “SYSTEM FOR AUTOMATICALLY SELLING AND PURCHASING HIGHLY TARGETED AND DYNAMIC ADVERTISING IMPRESSIONS USING A MIXTURE OF PRICE METRICS.” The Provisional Application Serial No. 60/443,358, filed on Jan. 28, 2003, and titled “SYSTEM FOR AUTOMATICALLY SELLING AND PURCHASING HIGHLY TARGETED AND DYNAMIC ADVERTISING IMPRESSIONS USING A MIXTURE OF PRICE METRICS” is hereby incorporated by reference.

### FIELD OF THE INVENTION

This invention relates to commercial advertising. More particularly, this invention relates to a system and method for generating and selecting targeted advertising using price metrics.

### BACKGROUND OF THE INVENTION

All forms of media derive revenue from advertising. Internet-based businesses sell advertising space on their Web sites to generate revenue. Mobile phone providers sell advertising space on their display devices. Print media such as newspapers and magazines sell advertising space on their pages. Advertisements are much more likely to result in a sale of the advertised goods or services when they are targeted to customers having characteristics suggesting that they may be interested in the goods or services.

U.S. Pat. No. 5,948,061 to Merriman et al. discloses methods and apparatuses for targeting the delivery of advertisements over a network. The system profiles a user and the network on which the user's system resides. The advertising server process uses the user's address and/or other information passed by the user's Web browser to determine an appropriate advertisement for display with the Web page returned to the user. Merriman et al. do not disclose using price metrics or content for determining which ads to target to a user.

U.S. Pat. No. 5,937,392 to Alberts discloses an Internet advertising system containing a database, a controller, and an ad server. The database has advertising campaign information, including identification information and frequency information. The ad server uses the campaign information from the database to control the relative ratios of serving ads, the distribution of ads throughout the day, and any triggering mechanisms for controlling what ads are served. Alberts does not disclose using price metrics or context for determining which ads to target to a user.

### SUMMARY OF THE INVENTION

A system and method for distributing advertising space advantageously maximizes the revenue generated by the advertising space. The system and method targets the advertising to those most likely to be interested in it, and thus most likely to act on the advertisement, either by purchasing advertised items or performing other acts related to the advertisement. The system and method categorize advertisements, thereby allowing them to be more efficiently targeted to consumers, and associate costs with each advertisement, thereby allowing the distribution of advertisements to be maximized.

In accordance with a first aspect of the invention, a method of distributing advertisements to a medium comprises classifying a plurality of messages according to a target criterion, selecting a message from the plurality of messages using a selection criterion, and delivering the selected message to a content site. Each message contains a corresponding advertisement. The selection criteria comprises a cost associated with the message. The selected message is delivered to a content site comprising a medium adapted to display the corresponding advertisement. Preferably, the content site meets one of a target, payment, and constraint of a message deal associated with the selected message. In one embodiment, the message is automatically generated based on a characteristic of the content site. The message is one of a text message, a video message, and an audio message. In another embodiment, the method further comprises tracking the delivery of a selected message, thereby generating tracking information.

In one embodiment, the selection criteria comprises a ranking of each of the plurality of messages. Preferably, the ranking is performed using one or more price metrics, each price metric related to a cost of displaying the advertisement on the medium. In another embodiment, the selection criterion further comprises a ratio of the display count of the advertisement to a display count of the remaining advertisements in the category. Preferably, classifying the plurality of messages is performed according to a classification scheme.

In another embodiment, the target criterion is that an advertisement is related to a characteristic of data related to a user. The characteristic is a topic entered by the user into a Web page, a keyword supplied to a search engine, a demographically identifiable content, a geographically identifiable content, or any combination of these.

The medium comprises a node on the Internet, a mobile phone display, a television set, or a radio signal. In another embodiment, the medium comprises a non-electronic medium such as a newspaper.

In accordance with a second aspect of the present invention, a method of organizing advertisements for distribution to a medium comprises placing a message containing an advertisement into a category and ranking each message in each category according to one or more ranking criteria.

In accordance with a third aspect of the present invention, a system for distributing advertisements to a medium comprises a database containing a plurality of messages organized by a targeting classification, a content inventory and deal manager for marketplace configured to select a message from the database according to a selection criteria, the selection criteria including a price metric, and a message server configured to transmit the selected message from the database to a content site. Preferably, the messages comprise a message selected from the group consisting of a text message, a video message, and an audio message. In one embodiment, the plurality of messages are ranked according to a ranking criterion. Preferably, the ranking criterion is related to a cost of displaying a message on a medium. Alternatively or additionally, the ranking criterion is related to the number of times that a message has been displayed on a medium.

In another embodiment, the system further comprises a content inventory and deal manager coupled to the marketplace. The content inventory and deal manager is configured to generate a tag embedded in a page configured to be transmitted to a user, the tag identifying a location for displaying an advertisement. In another embodiment, the system further comprises a tracking server coupled to the marketplace. The tracking server is configured to collect data on the messages transmitted to a content site. In another embodiment, the system further comprises an advertiser and campaign manager coupled to the marketplace. The advertiser and campaign manager is configured to manage campaigns, thereby generating a set of message deals that content sites can accept or reject. In another embodiment, the system further comprises an advertiser reporting system coupled to the marketplace. The advertiser reporting system is configured to collect data on message deals and generate reporting data. In another embodiment, the marketplace is further configured to transmit a message to a content site in response to a message deal of the message matching a business rule of the content site. In another embodiment, the content inventory and deal manager is configured to generate a tag embedded in a page configured to be transmitted to a content site, the tag identifying a location in the page for displaying the advertisement.

In accordance with a fourth aspect of the present invention, a system for distributing advertisements to a medium comprises an advertiser campaign manager, a storage device for storing a plurality of campaigns, a content inventory and deal manager, a marketplace, and a message server. The marketplace is coupled to the advertiser campaign manager, the storage device, the content inventory and deal manager, and the message server. The advertiser campaign manager is configured to generate a plurality of campaigns. Each campaign comprises a plurality of messages, targets, and a cost associated with each message. Each message having an associated advertisement. The content inventory and deal manager is configured to classify the plurality of messages and to associate a price metric with each message. The marketplace is configured to select a message from the database for distribution to a content site according to a selection criteria, including a price metric and a business rule of the content site. The message server is configured to transmit the selected message to a content site.

In one embodiment, the content inventory and deal manager is configured to classify the plurality of messages according to one of content classification, a demographic classification, or a geographic classification. In another embodiment, the advertiser campaign manager is configured to automatically generate a message based on the metadata of a product or service being advertised.

### BRIEF DESCRIPTION OF THE SEVERAL VIEWS OF THE DRAWINGS

FIG. 1A is a screen shot of a Web page for a search engine.

FIG. 1B is a screen shot of a Web page of the search engine of FIG. 1A, after the search engine has been invoked, containing a targeted advertisement in accordance with the present invention.

FIG. 2 is a flow chart for the steps to generate the targeted advertisement of FIG. 1B in accordance with the present invention.

FIG. 3 is a schematic of the components of an advertising distribution system in accordance with the present invention.

FIG. 4 is a schematic of an exemplary tree structure showing the organization of targets in accordance with the present invention.

### DETAILED DESCRIPTION OF THE INVENTION

In accordance with the present invention, a system is used to automatically buy and sell highly targeted and dynamic advertising impressions using a mixture of price metrics. Preferably, the advertising impressions are dynamic, including Internet-based impressions, mobile phones, personal digital assistants (PDAs), television, and radio. Alternatively, the advertising impressions are static, including such media as newspaper classified ads, and yellow pages.

The best results from advertising come from highly targeted, in-context advertising that presents the most relevant offer when a prospective buyer is looking or searching for information. In accordance with the present invention, highly relevant, in-context advertising is implemented using (1) content classification that is highly granular and (2) a large selection of advertisements equally well classified and relevant. The classification scheme for content is configured to handle at least 10,000 categories and millions of relevant offers and advertisements. The system automatically buys and sells billions of highly targeted impressions using the classification scheme. The system has actual liquidity (such as matching buy and sell offers) because it supports a variety of pricing schemes including, but not limited to, paying for impressions, paying for a variety of actions, or any combination of these.

The system can be used by one large seller of many content locations and many buyers, or it can be used by one large buyer (with many advertising offers) buying many content locations. Preferably, the system is a many-to-many implementation of both large and small buyers and sellers. Embodiments of the invention are implemented using a normal advertising contract that binds both buyer and seller to a particular campaign contract or using the more flexible system of allowing either the buyer or seller to cancel a non-performing contract.

In a preferred embodiment, a user accesses a content or media provider. The user's access triggers the content or media provider to classify the user. Using price metrics, the content or media provider then selects or generates advertisements that are provided by the advertiser and are likely of interest to the user. The content or media provider then transmits these targeted advertisements to the user. The targeted advertisements may be embedded or bundled with other information that the user has requested. Content providers include, but are not limited to, Web sites, mobile phone network providers, and Internet Service Providers.

Using embodiments of the present invention, media providers can classify, price, and manage the inventory of advertisements related to their media. Advertisers have the ability to buy highly granular inventory in an effective manner. Prospective customers have the ability to interact with advertisements to get more information.

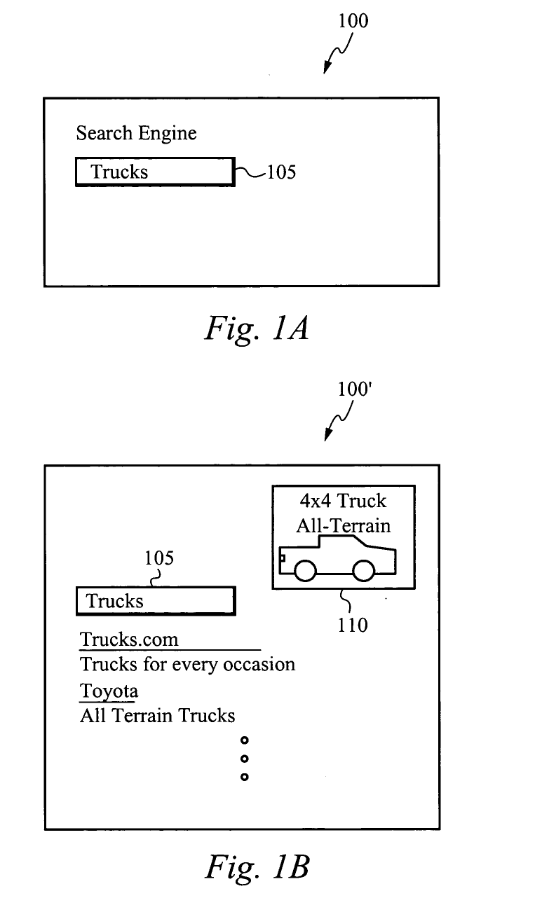

FIG. 1A is a screen shot of a Web page 100 of a search engine, used to describe a user's interaction with embodiments of the present invention. The Web page 100 contains an input field 105 for entering search terms, here the word “trucks.” When invoked, the search engine responds by displaying a Web page 100′ as shown in FIG. 1B. The Web page 100′ contains a list of Web sites containing information on trucks, but also contains a targeted advertisement 110 targeted to the user, that is, an advertisement likely to be of particular interest to the particular user. The targeted advertisement 110 is selected or generated based on the user's search terms (here, the word “truck”) and other information such as the user's geographic location (e.g., the physical location of the user's computer). Here, for example, the search term “truck” is combined with the user's geographic location, such as the outdoor locations in rural Minnesota, to determine that 4×4 trucks may be of particular interest to the user. The targeted advertisement 110 is then selected or generated, embedded within the Web page 100′, transmitted to the user's system, and displayed on the user's system along with the results of the user's request to the search engine, a list of Web sites containing the search term “trucks.” In one embodiment, the targeted advertisement 110 is located within the Web page 100′ using a content tag. It will be appreciated that while FIG. 1B illustrates the targeted advertisement 100′ in the right-hand corner of the Web page 100′, the targeted advertisement 110 can be placed in other locations of the Web page 100′ as determined by the content tag, which is embedded within the list of search results.

As described in more detail below, the targeted advertisement 110 is preferably selected from a group of advertisements in a two-step process. First, from a group of advertisements a candidate list of advertisements is selected, each advertisement targeted to a user. Second, from this candidate list, the targeted advertisement 110 is selected based on a price metric. Preferably, the targeted advertisement 110 is selected because its price metric is more favorable than the other advertisements in the candidate list. It will be appreciated that the targeted advertisement 110 can be selected using different steps or a different sequence of steps. For example, a candidate list of advertisements can first be selected using price metrics and then the targeted advertisement selected using criteria targeted to a user.

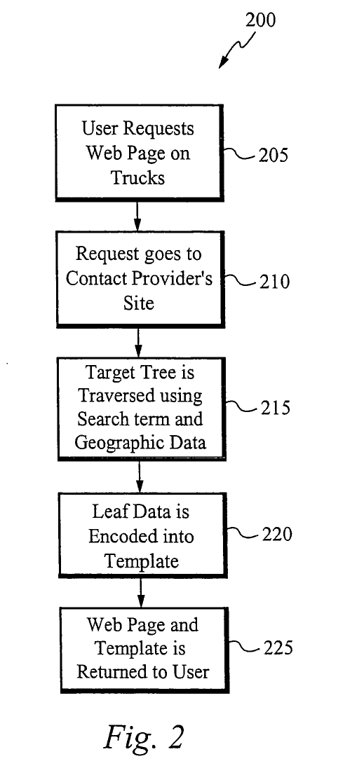

FIG. 2 shows steps 200 used to generate the targeted advertisement of FIGS. 1A and 1B in accordance with the present invention. First, in the step 205, the user requests a Web page on trucks, here using a search engine. Next, in the step 210, the request is transmitted to a content provider's Web site. Next, in the step 215, and as described in more detail below, the target tree is traversed, which contains candidate advertisements. One advertisement is selected from the candidate advertisements using a selection criteria which can include price metrics and geographical data, such as the user's location. Next, in the step 220, the selected advertisement is bundled with the Web page that the user requested and is encoded into the Web page using a template. Finally, in the step 225, the Web page with the selected advertisement is returned to the user.

It will be appreciated that while FIGS. 1A and 1B show targeted advertisements in accordance with the present invention displayed on a Web page, targeted advertisements displayed in accordance with the present invention are generated and displayed on other media in other environments including, but not limited to, electronic media such as mobile phones, wireless personal digital assistants (PDAs), and non-electronic media such as newspapers, and magazines.

As used herein, an impression refers to an opportunity for someone to see an advertisement. A static impression refers to an impression that is not fleeting or time based. This includes print advertising such as magazines and newspapers. A dynamic impression refers to an impression that is available for a pre-determined time period or duration. Once the time period or duration has elapsed, the opportunity to display and thus sell the dynamic advertisement also elapses.

Mass advertising refers to the opportunity for an advertisement to be seen by tens of thousands or even millions of people. Highly-targeted advertising refers to the opportunity for advertisements to be seen by hundreds or thousands of people. It also refers to advertisements that are seen with related content so that the combination of the advertisement and the content are seen by a few hundred people seeing the same combination.

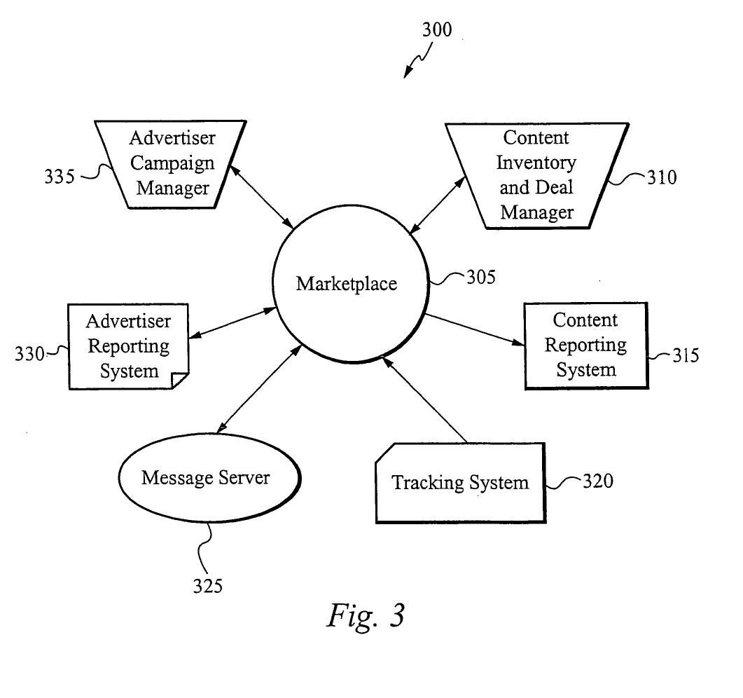

FIG. 3 illustrates the components of an advertising distribution system 300 in accordance with the present invention. The advertising distribution system 300 comprises a Marketplace System 305 coupled to a Content Inventory and Deal Manager 310, a Content Reporting System 315, a Tracking System 320, a Message Server 325, an Advertiser Reporting System 330, and an Advertiser Campaign Manager 335.

As a high-level overview, the Advertiser Campaign Manager 335, among other things, generates and edits campaigns. A campaign includes messages (containing advertisements) and information used to market the message. The Advertiser Campaign Manager 335 generates message deals, which the Marketplace System 305 transmits to the Content Inventory and Deal Manager 310. The Content Inventory and Deal Manager 310 accepts and rejects message deals, generating a list of acceptable messages for transmission to a particular site. Message deals are also categorized based on content, demographic classification, geographic classification, or other classification. Message deals are then accepted or rejected based on their price metrics. The Marketplace System 305 then manages message deals from the Content Inventory and Deal Manager 310 to the Message Server 325 (for transmission to a destination site), and to the Tracking System 320 and Advertiser Reporting System 330. Each of these components is now described in more detail.

The Advertiser Campaign Manager 335 (1) generates campaigns, (2) edits campaigns, (3) stops campaigns, either automatically or manually, (4) automatically generates messages based on product or item data, and (5) outputs a set of message deals for content sites to accept or reject. As described in more detail below, a message deal consists of a message (e.g., text, impression, sound, and voice), a target (e.g., content, category, channel, individuals, and devices) for the message, an amount to pay for delivering a message, and constraints to the message. The amount to pay for delivering a message can be in dollars per message delivered, dollars per message acted on, dollars per action attributed to the message, and any combination of these. Constraints to the message include, but are not limited to, date ranges, time ranges, and content sites to include or exclude.

Campaigns are an advertiser's high-level strategy, constraints, and parameters for displaying its advertisements at a particular target location. Campaigns include, for example, the advertisement, a date range that the advertisement is to be displayed, and delivery options, including context in which the advertisements are to be displayed. A campaign can also include constraints that ensure where the advertisement is to be displayed. For example, the advertiser may not want its advertisement to be displayed on an objectionable Web site. If so specified, the campaign will include this limitation. Once a campaign is executed, the system of the present invention generates and manages message deals for distributing and displaying the messages. As used herein, the words “message” and “advertisement” are used interchangeably.

Messages are of various types and formats, depending on the media on which it will be displayed and on the application at hand. For example, if the advertisement is to be displayed on a Web page encoded using hypertext mark-up language (HTML), the message can include text or graphics. If the advertisement is to be displayed on a mobile phone, the message can include text or voice. If the advertisement is to be displayed on media-rich devices such as personal computers and PDAs, the message can include video and sound.

Embodiments of the present invention also include an engine that automatically generates messages based on metadata on the products and services being advertised. Thus, for example, if a service contains metadata in a file or data structure, the engine will read the metadata and embed it in an advertisement generated as part of the service.

A target is a category, channel, search engine keyword, a specific content page, a type of content, demographically identified content, geographically identified content, and any combination or variation of these. Preferably, targets are arranged using tree or graph hierarchies to organize the content and demographic classification scheme. The target can be a leaf in a particular hierarchy or a branch which can include or exclude the lower branches and leafs in the hierarchy. Multiple hierarchies can be combined for a particular target. For example, “snowboarders in Tahoe, Calif.” combines the content classification of “sports->snowboarding” with the geographic classification of “US->CA->Tahoe”. The content classification also includes or excludes specific targets as modifiers to the initial target. For example, to target snowboarders who are not AOL™ subscribers, the content classification can include the “sports->snowboarding->equipment” AND NOT AOL. It will be appreciated that other boolean operators are used to tailor content classification in accordance with the present invention. Date ranges include the starting and ending dates, dates and times, or periods of times for delivering campaigns.

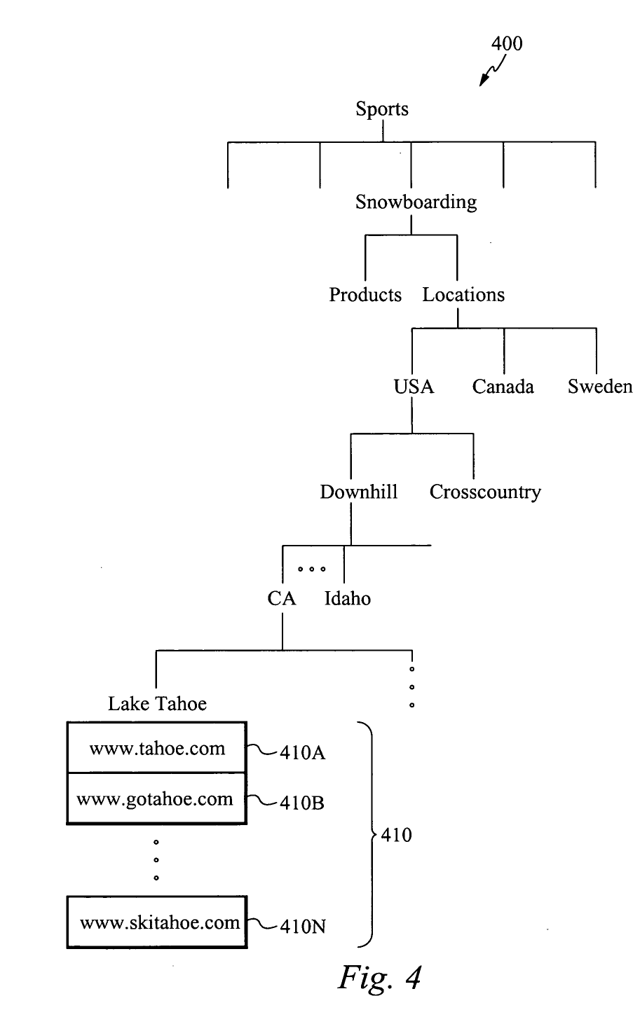

FIG. 4 illustrates one exemplary embodiment of a hierarchy, a tree structure 400, in accordance with the present invention. The tree structure 400 comprises a root element “sports”, a branch of “snowboarding” of the element sports, branches “products”and “locations” of the branch “snowboarding”, branches “USA”, “Canada”, and “Sweden” of the branch “locations”, branches “downhill” and “cross-country” of the branch “USA”, branches “CA” and “Idaho” of the branch “downhill”, and the leaf “Lake Tahoe” of the branch “CA”. The leaf “Lake Tahoe” has associated with it a plurality of objects 410, including a first object 410A having an associated URL www.tahoe.com, a second object 410B having an associated URL www.gotahoe.com, and an Nth object 410N having an associated URL www.skitahoe.com.

As described in more detail below, preferably the object 410A, the object 410B, and the object 410N each has an associated price metric. When a user triggers an advertising distribution system to generate an advertisement, the advertising distribution system will traverse the tree structure 300 to determine a candidate list of targets (e.g., 410). The advertising distribution system then uses the price metric associated with each target and any other selection criteria (e.g., constraints) in determining at which target of the list of targets the advertisement is to be displayed. Thus, for example, if object 410A is selected based on its price metrics and/or other criteria, a Web page found at www.tahoe.com is included in the target list of sites to display the message.

As an example, an advertiser may wish to display the message “Burton™ snowboard X100 on sale”. This advertisement will be targeted to sites matching the content classification of “sports->snowboarding” and the geographic classification of “US->CA->Tahoe.” The Web site www.tahoe.com is such as site. Thus, when a user loads the Web page at www.tahoe.com the targeted advertisement “Burton™ snowboard X100 on sale” will be included in the Web page ultimately displayed on the user's system.

Payments refer to the amount of the offer paid by the advertiser to the content provider to display a message. The payment is based on a number of factors including, but not limited to, the number of impressions delivered, the number of ‘clicks’, the number of user interactions with the advertisement, or the actual action suggested by the advertisement, such as a purchase or a registration. Embodiments of the present invention allow for both ‘OR’ and ‘AND’ combinations of payments. For example, payments can be based on payment by impression (CPM) AND payment by revenue sharing of the purchase suggested by the message. Embodiments of the present invention also convert non-impression payments to an “effective impression payment” (eCPM) to normalize all of the buys into a figure that is relevant to the content provider. This latter embodiment advantageously delivers the highest paying offers more often, given similar relevancy, even if there are different offers within the system.

There are several limiting factors such as overall budget limit, campaign limit, daily offer limit, number of items sold by a campaign, and number of times a single offer is delivered to a customer. Delivery options include, but are not limited to, the time for delivery, and the priority of delivery.

Any one or more of the above elements can be edited: the messages, the target, the date range, the payment, the limits, and the delivery options. As soon as any one of the elements is changed, that is the rules have been changed, the campaign begins delivering in accordance with the new rules.

Campaigns are stopped or deleted in a variety of circumstances. For example, the campaign may reach its limit and stop automatically. If the campaign contract delivery and the time line are not restrictive, the campaign can also be stopped manually. A restrictive contract binds the buyer and the seller to a particular campaign contract of delivering and buying a certain number of impressions. A non-restrictive contract allows either side of the contract to stop a non-performing campaign.

The Advertiser Campaign Manager automatically generates messages based on product or item data. Such a structure is necessary given the sheer number of messages being delivered to achieve the highly targeted functionality. The advertiser has the ability to review the messages from the system's Message Creator and manually modify or edit the messages to suit its needs. The Message Creator takes metadata from the products, services, or messages being delivered and transforms or combines them into specific messages for the target content. The metadata can be automatically uploaded from many locations including, but not limited to, a Web site, a database, a structure having a record or field format (e.g., a spreadsheet). The transformation is implemented using templates, which indicate the order, location, size, font (if relevant), and other details of where the metadata is to be displayed in its final delivery to the target content.

The output of the Advertiser Campaign Manager 335 is a set of message deals for the sites to accept or reject. A message deal consists of (1) a message, which includes but is not limited to, text, image, sound, voice, video, or any combination of these, (2) the result of a customer interaction with the message, which can include a URL to a link if the user ‘clicks’ on the message, a graphic showing a coupon to print, other information delivered by sound or voice, (3) the target for the message, including content, category, channel, individuals, and devices, (4) the amount to pay for delivering the message, which can be an amount per message delivered, an amount per message acted on, an amount per action attributed to the message, or any combination of these, and (5) constraints to the message, such as date ranges, time ranges, content sites to include or exclude, or any combination of these. The Marketplace System 305 will deliver the relevant message deals to the content sites that meet the target, payments, and constraints of the message deal. A Message Creator generates the appropriate message instance to be delivered to each content site. The Marketplace System 305 works with the Tracking and Reporting Systems to facilitate the optimization and reporting of the campaign based on the results of the message deals.

The Advertiser Reporting System 330 reports on the campaigns, messages, sites, target classifications (such as categories, channels, geographic targets, or other targeting classifications), and results from user actions, such as clicks, registrations, or purchases.

The Advertiser Reporting System 330 reports on campaigns, messages, targets, and advertiser's sites or actions. When reporting on campaigns, the Advertiser Reporting System 330 provides a summary and detailed report for each campaign within the date range specified. The Advertiser Reporting System 330 also provides sub reports of campaign offers. For messages, the Advertiser Reporting System 330 provides a summary and detailed report for each message within the date range specified. For targets, the Advertiser Reporting System 330 provides a summary and a detailed report for each target, including impressions, clicks, and user actions. For advertiser's sites or actions, the Advertiser Reporting System 330 provides a summary and detailed report for each activity being tracked. This can include the number of users that interact with a message but do not register or purchase an item.

The Marketplace System 305 (1) interacts with the Advertiser Campaign Manager 335, the Content Inventory and Deal Manager 310, the Content Reporting System 315, the Tracking System 320, the Message Server 325, and the Advertiser Reporting System 330, (2) schedules the delivery and retrieval of information, (3) maintains the states of each component so that they are all coordinated, (4) manages the message deals from the Advertiser Campaign Manager 335, to the Content Inventory and Deal Manager 310, to the Message Server 325, and to the Tracking and Reporting Systems (315, 320, and 330), (5) optimizes the delivery of message deals based on constraints imposed by the advertiser and the content site, and (6) provides inventory management services to the Advertiser Campaign Manager 335, the Content Inventory and Deal Manager 310, and the Message Servers 325.

It will be appreciated that depending on the context, each component discussed above, such as a message server, refers to both a host machine as well as an instance of a process running on a host machine and used to perform the tasks associated with the component. While FIG. 3 depicts one of each component, it will be appreciated that the present invention encompasses several instances of a particular component. Thus, the Marketplace System 305 must track and manage not just a single component, but also each instance of a component. For a message server, data is replicated on each message server and each server supports a set of end users to better balance the load. For example, a load balancer, router, or similar device distributes the load among message servers using a distribution algorithm that ensures that a user is directed to the same message server during a single session.

It will also be appreciated that a Marketplace System 305 can have more than one instance to handle the load on a given hardware platform. In this embodiment, sub-systems of each Marketplace System 305 are coordinated, synchronizing data on a regular basis in order to maintain data consistency and integrity.

In interfacing with all the other components, the Marketplace System 305 (1) receives message deals from the Advertiser Campaign Manager 335, (2) delivers the message deals to the Content Inventory and Deal Manager 310, (3) delivers the approved and rejected list to the Message Server 325 and the Tracking System 220, (4) provides needed data to the Content Reporting System 215 and the Advertiser Reporting System 315, (5) provides inventory estimates to the Advertiser Campaign Manager 235, to the Content Inventory and Deal Manager 310, and to the Message Server 325, and (6) delivers optimization priorities to the Message Server 325 based on the campaign goals and results seen by the Tracking System 220.

In scheduling the delivery and retrieval of information, each component receives and returns data. Those skilled in the art will appreciate that this data exchange employs protocols to handle security, breaks in communication including the retransmission of data and the like. This data exchange must be performed regularly to distribute system load as well as to maintain the state of each sub-component.

The Marketplace System 305 coordinates each component to maintain the component's state. To effectively manage the changes in campaigns and changes forced due to events such as a campaign limit being reached, the Marketplace System 305 keeps track of three states: (1) the previous state, including but not limited to information related to impressions, clicks, and purchases; (2) the current state, including but not limited to information related to what advertisements are being offered and what are the current limits and targets; and (3) the next state, which is loaded into the Marketplace System 305 so that at the next transition there is a smooth transition from the current state to the next, much as pipelining in microprocessors.

The Marketplace System 305 also manages the message deals from the Advertiser Campaign Manager 235 to the Content Inventory and Deal Manager 310, and then to the Message Server 325, Tracking System 320, Content Reporting System 315, and Advertiser Reporting System 330. Once the campaign is generated, the message deals are transmitted to the Content Inventory and Deal Manager 310 for approval. If the campaign is edited or deleted, then the updates are filtered to the Content Inventory and Deal Manager 310, Tracking System, 320, Content Reporting System 315, and Advertiser Reporting System 330.

After the Content Inventory and Deal Manager 310 has approved the message deals, the message deals are transmitted to the Message Server 325, which delivers them to a content site and to the Tracking System 320 for tracking. State changes are also provided to the Tracking System 320, Content Reporting System 315, and Advertiser Reporting System 330, such as when the campaign is closed or updated. When the campaign is being delivered, the Marketplace System 305 retrieves from the Message Server 325 the needed impressions and clicks and stores them for use by the Content Reporting System 315, Advertiser Reporting System 330, and Optimization System. When a prospective customer interacts with the messages and registrations, purchases, or other actions, the campaign limits are being tracked. For example, if only 100 widgets are to be sold as part of a campaign, delivery of messages are to be stopped when the 100^{th} widget is sold. Because it is impractical to continuously and perfectly track and update a system, one option is to have the system stop sending messages before the 100^{th} widget is sold, ensuring that advertisements are not over-delivered. The time to stop is dependent on the frequency of updates for the system. The hysteresis for over or under delivery based on actions beyond the click can be set for the whole system or for a particular account. The Marketplace System 305 also provides the needed information to the reporting system.

The Marketplace System 305 also optimizes for the delivery of message deals based on the constraints imposed by the advertiser and the content site. For example, the system provides default goals for the optimization, although these can be updated and/or edited to reflect specific goals of the advertiser or the content provider. Default goals include, but are not limited to, maximizing the return on investment (ROI) for a campaign, maximizing the ROI for content sites, balancing the delivery of messages based on campaign duration and inventory, and delivering more of the higher paying messages to a site given different priced messages.

The Marketplace System 305 also provides management services to the Advertiser Campaign Manager 335, the Content Inventory and Deal Manager 310, and the Message Servers 325. For example, as the Advertiser Campaign Manager 335 is being generated, the Marketplace System 305 provides estimates of impressions, costs and results to a proposed campaign of messages, targets, and payments. While the Content Inventory and Deal Manager 310 is determining what content to make available for messages, it must determine (1) how many message deals are targeted to a particular branch or leaf of the target tree, (2) the average payment, and (3) the number of messages that are available to be accepted. As the Message Server 325 is building its list of messages to be delivered, it must determine when to stop a particular message such as when a campaign limit has been reached.

A Marketplace Database System stores the different entities in the system including campaigns, message deals, targets, and user actions. Preferably, the Marketplace Database System stores these entities in a relational database so that tables can be share keys and can thus be used efficiently. The Marketplace Database System also functions as a backup database, storing backup data for one or more of the components in an advertising distribution system.

The Marketplace Database System stores (1) each detail of a campaign, clearly related to the offers, target audience, and redemptions; (2) message deals including the original metadata and the instances of the message to be delivered to the different targets; (3) targets, organized as a tree or graph, with constraints, active messages, pending messages, and rejected messages that were targeted to it; and (4) user actions, such as, for each advertiser's tracking area, a record of purchases including date, stock keeping unit (SKU) purchases, and price of purchase. These items must be corelated to allow efficient reporting for the advertiser and content provider.

The Message Server 325 (1) delivers the right message to the right target location, (2) counts the number of messages delivered, (3) sends the prospective customer interacting with the message to the right location, and (4) counts the number of customer interactions with the message. The system is designed to efficiently handle millions of messages. It further focuses on highly targeted message delivery and uses an algorithm for delivering messages from a set of applicable messages for a given target.

In accordance with the present invention, the Message Server 325 has the ability to deliver messages in a number of ways. First, the Message Server 325 delivers messages using a third-party ad server, such as when using Internet-based services. Third-party servers are generally used to deliver advertisements when redirection is used to get an Internet browser requesting a variety of content from a Web page to come and request the message from the Message Server 325. The Message Server 325 then delivers the message and the browser represents to the user a content page with the message embedded. This system uses a “message tag” which each content site places on its content Web page. Second, the Message Server 325 can use a direct connection between the Content Inventory and Deal Manager 310 and the Advertiser Campaign Manager 335. This uses Internet or other methods and preferably uses XML or other protocols for data transfer.

The Message Server 325 delivers the right message to the right target location. For each target location there is a list of messages to be delivered. The Marketplace System 305 filters the message deals and delivers only those messages that fit a particular target location, that is, meet the message deal's business rules, meet the target location's size, or meets other restrictions. Each message in the target location list has a weight ratio, which determines the percentage of the rotation that each message will have. The percent of the rotation increases based on a number of factors. Preferably, the percent of rotation increases for a message that has a higher effective CPM (eCPM) than the other messages in the list. There may be other factors such as under-delivery of a particular message that needs to “catch up” before the end of the campaign.

The Message Server 325 also counts the number of messages that have been delivered. A message is counted as delivered when the last byte of the data is successfully sent. If the message is not fully delivered due to a number of factors (such as the interruption of a connection between the Message Server 325 and the end user's browser in Internet-based messages), then the message is not counted as being delivered.

Owing to a variety of network topologies and caching mechanisms, a message may be delivered to an end customer without using the Message Server 325. For example, a caching server is used to send an advertisement to a customer without contacting the Message Server 325. The Message Server 325 can also use standard “cache-busting” techniques. The Message Server 325 also sends the prospective customer interacting with the message to the right location and counts the number of customer interactions with the message.

As described above, the overall system will have more than one Marketplace sub-system and more than one Message Server 325 associated with the Marketplace System 305.

In one embodiment, each Message Server 325 has content tags at the content site and all the messages are targeted to them. This works with millions of content-based message tuples. The Message Server 325 is configured to have a fast access index and sufficient RAM and disk space to hold the tuples.

When a user requests a message from a Message Server 325, the Message Server 325 tracks what was delivered to which user. This requires some level of differentiation between users requesting data from a Message Server 325. Preferably, the Message Server 325 is configured to differentiate between users.

The Tracking System 320 tracks actions beyond the message. For example, once a prospective customer has interacted with the message, the Tracking System 320 tracks “follow on” actions, requiring tracking technology at the advertiser's site. Tracking is performed by the Tracking Server or by the advertiser's systems with the data sent back to the Marketplace System 305 for processing.

Tracking can be performed by the Tracking System 320 either directly or indirectly. Direct tracking is done using a message/tracking tag similar to the one used for delivering messages. Depending on the level of the tracking, the Tracking System 320 tracks that a customer landed on a page, registered, or made a purchase. The Tracking System 320 can also track an actual purchase if the advertiser's site provides the data via the message tag. In other dynamic media, the action is the delivery of a follow-on message or an automatic call message sent by the end user to the advertiser in response to a message.

Direct tracking needs to be done over a period of time and is per individual. An end user may ‘click’ on a message, land on a page within minutes of seeing the message, but may purchase an item at the advertiser's site days, weeks, or even months after seeing the original message. Accordingly, the Tracking System 320 is configured to track the individual's actions and trace them back to the original message. Indirect tracking is performed when the advertiser's system sends the tracking information to the Tracking System 320 and the data is then incorporated into the Marketplace System 305.

In either case, the Tracking System's 320 tracking and delivery methods and records are preferably capable of being audited by a third party to allow both the buyers and sellers of messages to confirm that their purchase is accurately tracked.

Here, the ratio of delivered messages to actions that are tracked is preferably 10:1, so the performance load on the Tracking System 320 is different than that on the Message Server 325. The Tracking System 320 is configured to track performance over a longer period of time (e.g., 90 days). So the load is in having a database that allows it to track millions of user interactions over a relatively long period of time.

For the Content Inventory and Deal Manager 310, the content site or network manager sets the content context (e.g., the content classification and/or demographic and/or geographic context), the content minimum price for a message deal and any other deal constraints (e.g., advertiser to be included or excluded from presenting a message on the content page). The content site manager also manually accepts or rejects message deals presented by the Marketplace System 305. Even though these deals have met the content context constraints, the Content Inventory and Deal Manager 310 may still go over the message deals and accept or reject them.

As used herein, a message location is a location within the content page where the message of a given message deal is presented. There may be more than one message location per content page. A content page includes, but is not limited to, a Web site page, a cell phone message, a PDA page/message, a magazine page, a TV program, and a radio show. A message location within a content page is an opportunity to display a message within the content. A message location includes, but is not limited to, a space within a Web site page, a space within a phone text message window, a space within a magazine page, or a space/time slot within a TV program. The message type can be text, graphical, voice, or video. The message size can be in units that refers to the type of message: text messages have the units of character, graphics messages have the units of pixels.

The minimum price to display a message is the lowest price accepted to display a message within the content page. The metric used for the minimum price is impression based (usually per 1,000 impressions) or per action. The actions are either an interaction with a user, such as a click; a post-message interaction, which is at the advertiser's site or a call center. The actions are either a ‘click’, such as when a user interacts with the message; or post-message interaction, which is at the advertiser's site or call center. The payment is a fixed amount or a share of the revenues generated by the message's post-actions.

As used herein, context classification refers to content classification, demographic classification, geographic classification, or other classification. Effective CPM (eCPM) refers to effective cost per thousand impressions. This is calculated from a particular deal's actual performance as compared to the number of impressions it took to achieve a given performance. If 1,000 impressions are shown, and 10 people click on the message and 1 person makes a $100 purchase and the deal is a 5% revenue share, then the effective CPM is $5.00. A forecast effective CPM (feCPM) refers to a forecast effective cost per thousand impressions. This is what one would expect to get on a particular deal, based on other similar deals' performance on the Marketplace System.

The content inventory and deal manager performs the following functions to introduce a message location in the Marketplace System 305:

1. Set the Message Location. The result is usually a ‘tag’ which the content site will embed in their site pages. In the case of a magazine, TV program or radio program the system provides an identifier to indicate when/where to show the message.

2. Set the minimum price to display the message.

3. Set the content classification of the message to be displayed.

4. Set the date/time range for the message location to be ‘live’.

5. Set any inclusion or exclusion rules re: advertisers. There may be either a category of advertisers (i.e. Pornography vendors) or a specific set of advertisers that are excluded from advertising. The opposite can also be set—a set of advertiser(s) or category that is included at the exclusion of all others.

6. Given a message location that is ‘live’ in the Marketplace System 305. The system then presents a set of message deals that meet the requirements of the message location. The Content Inventory and Deal Manager 310 then determines whether the deals are accepted automatically or manually.

Given a set of message locations with live deals running on them, a content site manager has the ability to cancel any deals running on his/her site. Because the deals are dynamic and performance based, the following rules are applied to a given message deal:

1. Any side of the deal (site or advertiser) has the ability to cancel the deal at any time.

2. Any side has the ability to change the parameters of an ongoing campaign. This may mean that the deals are ‘canceled’ and re-submitted and not all deals may ‘land’ on the same place.

3. The deal with the highest effective CPM will get the highest percent rotation on a given message location. If the deal has no effective CPM (i.e. at the start of a deal) then the feCPM is used to calculate the actual eCPM for the deal on the specific location. Once the deal has some statistically significant data then the eCPM is calculated and used instead of the feCPM.

The percent rotation for a given deal can be calculated in several ways. The first and simplest approach is to use the eCPM as a weighted average. Thus, for example, if there are 3 deals on a message location that has a $1.00 minimum eCPM, and if there are deals ranging from $10.00 to $1.00 targeted to this message location, then the percent rotation goes as follows: If one deal has an eCPM (or feCPM) of $10, another deal has an eCPM of $5, and another deal has an eCPM of $1, then the rotation would be as follows:

The $10 eCPM deal gets 10/(10+5+1) of the rotation. In this case 62.5% of the rotation.

The $5 eCPM deal gets 5/(10+5+1) of the rotation. In this case 31.25%.

The $1 eCPM deal gets 1/(10+5+1) of the rotation. In this case 6.25%.

The percentage of rotation is based on a random rotation pattern. The principle is that a site should provide an opportunity for advertisers to try a given location to see what results they are able to obtain. Once a deal is in a rotation it is guaranteed a percentage of the impressions of a given location. This allows the deal to develop an eCPM for that location (instead of the feCPM used to start the rotation). This eCPM for a given deal on a given location then either increases the rotation of a deal within the location or ‘bumps’ the deal off the location due to an eCPM that is below the location's minimum. There is a hysteresis for a deal to go from feCPM to eCPM. This hysteresis is expressed in terms of impressions. A content site manager has the ability to set the hysteresis for a given site, or use the default hysteresis which is statistically calculated based on the results of the marketplace or possibly sites similar to the one in question.

Embodiments of the present invention also allow calculating the available inventory of impressions for either a given location or a set of locations. This calculation is done usually in order to be able to sell an advertiser a given set of impressions to meet the advertiser's budget or goals for a given campaign. The problem for most systems is predicting the impression levels for highly targeted inventory. With traditional advertising systems the inventory is ‘locked up’ when a purchase is made, so the system needs to make an estimate of how many impressions there will be in the future based on past performance. Given a larger number of impressions (for example over 5,000 per month) and given a smaller set of locations (for example under 1,000), then most systems produce a reasonable prediction of future impressions or available inventory. The problem not easily handled by most systems is how to predict inventory over 100,000 or 1 million locations that have less than 500 impressions per month, or maybe only 50 monthly impressions. Clearly an advertiser may want to purchase only one or two of these locations or may want to purchase a set of 100 locations in a branch of the location hierarchy, each location with only 50 to 100 impressions—which come out to 50,000 to 100,000 very targeted impressions per month. Most systems assume that the available inventory is being sold using one metric—CPM (Cost per 1,000 impressions). This invention allows the highly targeted inventory to be bought using any combination of 4 or more metrics, which are combined into an effective CPM (eCPM).

Embodiments of the present invention also solve the available inventory problem by introducing two concepts: (1) a minimum price (eCPM, or any other metric if needed) to be paid in order for a Message Deal to be shown at the given location and (2) a price based rotation for a given Message Deal, in which the higher priced Message Deals are given a proportionally higher level of rotation.

Other embodiments include the following optional enhancements, not required for the Content Inventory and Deal Manager 310 to perform: (1) freedom by either site or advertiser to cancel any deal at any time, (2) a trial period for a given deal to enter a location's rotation based on estimated metrics (feCPM or other metric); thus, if a Message Deal does not have the calculated metrics, then the system estimates the performance of the Deal at a given location, based on prior location-Deal performance; and (3) a sufficient level of ‘liquidity’ in the marketplace—a reasonable balance of locations and deals targeted to the locations.

In accordance with the present invention, it is guaranteed that there will always be available inventory for any advertiser willing to pay the minimum price for a set of locations. The amount of available inventory for a given advertiser will vary based on how much it is willing to pay. The payment may be direct (by impression) or an estimated eCPM (feCPM) calculated based on the previous results of a given deal-location combination. Eventually the system is able to move from an estimated eCPM (feCPM) to a calculated one based on actual performance.

The available inventory for a given Message Deal is the sum of the inventory available on all the locations that meet the Message Deal's requirements and that are at or below the amount being paid by the Message Deal. This available inventory assumes the prices on the locations do not change or the payment from the Message Deal does not vary over the length of the campaign.

The system of the present invention is used to determine the number of impressions available for requirements such as category, demographic or geographic. The system is also used to optimally meet the goals of a campaign across the available inventory, to determine the number of orders that can be expected at $10 cost per order, and the number of visits to a site if the advertiser pays $0.25 per visit. Furthermore, the system has the ability to optimize for getting the most orders at $10 per order from the available inventory.

When determining how many orders to expect if the advertiser pays $10 per order, the system first calculates an effective CPM (eCPM) based on the advertiser's category within the system as well as the previous performance. If there is no previous performance for the given advertiser, then the eCPM is estimated based on previous performances for similar advertisers (i.e. within the same category). Once an estimated eCPM (feCPM) is calculated then the system determines what site locations are at or below the eCPM (feCPM) and the deal's targeting and other requirements. Finally, the total of all the eligible locations is the available inventory for the advertiser's Message Deal.

When determining how many visits to a site an advertiser can get if it pays $0.25 per visit, the advertiser's conversion metrics do not have to be calculated, only the site's click through (CTR) metrics combined with the actual advertiser's CTR metrics. Again, if no advertiser CTR metrics are available, then the average category metrics are used to make an estimate, which is revised after the allocated window for making the updates to the eCPM metrics (defined earlier).

Embodiments of the present invention advantageously allow for the placement of highly targeted advertisements, increasing the likelihood that the advertisements will be acted on, and thus increasing the return on investment for each advertisement. The return on investment is further increased by using an algorithm that displays more profitable advertisements more often and rotates the display of advertisements. Advertisements are categorized using tree or other hierarchical structures that are scalable and are easily configurable, increasing the flexibility of the system of the present invention. Actions related to the advertisements are tracked so that the system can be optimized and fine tuned.

It will be readily apparent to one skilled in the art that various modifications may be made to the embodiments without departing from the spirit and scope of the invention as defined by the appended claims.

I claim:

1. A method of distributing advertisements to a medium, the method comprising:
a. classifying a plurality of messages according to a target criterion, each message containing a corresponding advertisement;
b. selecting a message from the plurality of messages using a selection criterion, the selection criteria comprising a cost associated with the message; and
c. delivering the selected message to a content site comprising a medium adapted to display the corresponding advertisement.

2. The method of claim 1, wherein the selection criterion is that the content site meets one of a target, payment, and constraint of a message deal associated with the selected message.

3. The method of claim 1, wherein the message is automatically generated based on a characteristic of the content site.

4. The method of claim 1, wherein the message is selected from the group consisting of a text message, a video message, and an audio message.

5. The method of claim 1, further comprising tracking the delivery of a selected message, thereby generating tracking information.

6. The method of claim 1, wherein the selection criteria comprises a ranking of each of the plurality of messages.

7. The method of claim 6, wherein the ranking is performed using one or more price metrics, each price metric related to a cost of displaying the advertisement on the media.

8. The method of claim 7, wherein the selection criterion further comprises a ratio of the display count of the advertisement to a display count of the remaining advertisements in the category.

9. The method of claim 1, wherein classifying the plurality of messages is performed according to a classification scheme.

10. The method of claim 1, wherein the target criterion is that an advertisement is related to a characteristic of data related to a user.

11. The method of claim 10, wherein the characteristic is a topic entered by the user into a Web page.

12. The method of claim 10, wherein the characteristic is a keyword supplied to a search engine.

13. The method of claim 10, wherein the characteristic is a demographically identifiable content.

14. The method of claim 10, wherein the characteristic is a geographically identifiable content.

15. The method of claim 1, wherein the media comprises a node on the Internet.

16. The method of claim 1, wherein the medium comprises a mobile phone display.

17. The method of claim 1, wherein the medium comprises a television set.

18. The method of claim 1, wherein the medium comprises a radio signal.

19. The method of claim 1, wherein the medium comprises a non-electronic medium.

20. The method of claim 20, wherein the non-electronic medium comprises a newspaper.

21. A method of organizing advertisements for distribution to a medium, the method comprising:
a. placing a message containing an advertisement into a category; and
b. ranking each message in each category according to one or more ranking criteria.

22. A system for distributing advertisements to a medium, the system comprising:
a. a database containing a plurality of messages organized by a targeting classification;
b. a content inventory and inventory and deal manager configured to select a message from the database according to a selection criteria, the selection criteria including a price metric; and
c. a message server configured to transmit the selected message from the database to a content site.

23. The system of claim 22, wherein the messages comprise a message selected from the group consisting of a text message, a video message, and an audio message.

24. The system of claim 22, wherein the plurality of messages are ranked according to a ranking criterion.

25. The system of claim 24, wherein the ranking criterion is related to a cost of displaying a message on a medium.

26. The system of claim 24, wherein the ranking criterion is related to the number of times that a message has been displayed on a medium.

27. The system of claim 22, further comprising a marketplace coupled to the content inventory and deal manager, the marketplace configured to transmit a selected message to a content site.

28. The system of claim 27, further comprising a tracking server coupled to the marketplace, the tracking server configured to collect data on the messages transmitted to a content site.

29. The system of claim 28, further comprising an advertiser and campaign manager coupled to the marketplace, the advertiser and campaign manager configured to manage campaigns, thereby generating a set of message deals that content sites can accept or reject.

30. The system of claim 29, further comprising an advertiser reporting system coupled to the marketplace, the advertiser reporting system configured to collect data on message deals and generate reporting data.

31. The system of claim 27, wherein the marketplace is further configured to transmit a message to a content site in response to a message deal of a message matching a business rule of the content site.

32. The system of claim 22, wherein the content inventory and deal manager is configured to generate a tag embedded in a page configured to be transmitted to a content site, the tag identifying a location in the page for displaying the advertisement.

33. A system for distributing advertisements to a medium, the system comprising:
a. an advertiser campaign manager configured to generate a plurality of campaigns, each campaign comprising a plurality of messages, targets, and a cost associated with each message, each message having an associated advertisement;
b. a storage device for storing the plurality of campaigns;
c. a content inventory and deal manager configured to classify the plurality of messages and to associate a price metric with each message;
d. a marketplace configured to select a message from the database for distribution to a content site according to a selection criteria, the selection criteria including a price metric and a business rule of the content site; and
e. a message server configured to transmit the selected message to a content site, wherein the marketplace is coupled to the advertiser campaign manager, the storage device, the content inventory and deal manager, and the message server.

34. The system of claim 33, wherein the content inventory and deal manager is configured to classify the plurality of messages according to one of content classification, a demographic classification, or a geographic classification.

35. The system of claim 33, wherein the advertiser campaign manager is configured to automatically generate a message based on the metadata of a product or service being advertised.
